(19) United States
(12) Patent Application Publication
(10) Pub. No.: US 2025/0029799 A1
(43) Pub. Date: Jan. 23, 2025

(54) ARC EXTINGUISHING SYSTEM FOR CONTACTOR AND CONTACTOR

(71) Applicant: Schneider Electric Industries SAS, Rueil-Malmaison (FR)

(72) Inventors: Xu Han, Shanghai (CN); Yuanzhong Wang, Shanghai (CN); Zhiping Huan, Shanghai (CN); Shaofan Li, Shanghai (CN)

(73) Assignee: Schneider Electric Industries SAS, Rueil-Malmaison (FR)

(21) Appl. No.: 18/749,978

(22) Filed: Jun. 21, 2024

(30) Foreign Application Priority Data
Jul. 19, 2023 (CN) 202321911137.3

(51) Int. Cl. H01H 33/10; H01H 33/72

(52) U.S. Cl. CPC H01H 33/10; H01H 33/72

(57) ABSTRACT

The present disclosure relates to an arc extinguishing system for contactor and a contactor. The arc extinguishing system includes: an arc extinguishing chamber, accommodating a plurality of arc extinguishing grids, and an extension direction of each of the plurality of arc extinguishing grids being perpendicular to an extension direction of the movable contact; an arc striking piece, electrically connected to the stationary contact and configured to extend toward the arc extinguishing chamber, so that the arc generated upon the movable contact and the stationary contact being separated moves along the arc striking piece toward the arc extinguishing chamber.

### TECHNICAL FIELD

The present disclosure relates to an arc extinguishing system for contactor and a contactor.

### BACKGROUND

For a contactor that needs an arc extinguishing chamber to extinguish arc, a plurality of arc extinguishing grids are often arranged in the arc extinguishing chamber. When the arc strikes on the arc extinguishing grids, the arc is cut into several sections, and the arc is extinguished by increasing the arc voltage. In order to allow the arc to completely enter the arc extinguishing grids, it is needed to attract the arc to move outward by using the magnetic field generated by the arc. In order to achieve this purpose, a J-shaped stationary contact is usually used to attract the arc to move outward through the magnetic field generated by reverse current. However, a J-shaped contact needs more copper because of bending, it is expensive and difficult to control the size, and the depth of the product itself needs to be increased to accommodate the J-shaped contact; another solution is to utilize a J-shaped arc striking piece to make the arc move outward through the magnetic field generated by the reverse current on the J-shaped arc striking piece. However, the existing J-shaped arc striking piece is located on both sides of the stationary contact, and the arc extinguishing grids are arranged in parallel with the movable contact, so the pollutants in the arc extinguishing chamber may fall on the movable contact to pollute the movable contact and affect the electrical life of the product.

### SUMMARY

In order to solve the abovementioned problems, the present application provides an arc extinguishing system for contactor, used for extinguishing an arc generated upon a movable contact and a stationary contact of the contactor being separated, wherein the arc extinguishing system includes: an arc extinguishing chamber, accommodating a plurality of arc extinguishing grids, and an extension direction of each of the plurality of arc extinguishing grids being perpendicular to an extension direction of the movable contact; and an arc striking piece, electrically connected to the stationary contact and configured to extend toward the arc extinguishing chamber, so that the arc generated upon the movable contact and the stationary contact being separated moves along the arc striking piece toward the arc extinguishing chamber.

Advantageously, the arc striking piece includes a connection part configured to be electrically connected to the stationary contact and a guide part spaced apart from the stationary contact and guiding the arc.

Advantageously, the connection part includes a first part, a second part and a bending part connecting the first part and the second part, the first part, the bending part and the second part form a substantially U-shape, the first part is electrically connected to the stationary contact, and the second part is connected to the guide part, and the arc flows from the first part to the second part through the bending part.

Advantageously, the guide part includes a tail part extending perpendicular to the stationary contact and a transition part connecting the second part and the tail part.

Advantageously, the guide part includes a groove centrally arranged in the guide part.

Advantageously, the tail part includes a first inclined lateral edge and a second inclined lateral edge, so that the first inclined lateral edge and the second inclined lateral edge converge towards a middle of the tail part to form a tip.

Advantageously, the guide part extends past the plurality of arc extinguishing grids so that the guide part partially surrounds the plurality of arc extinguishing grids.

The present application further provides a contactor, including the abovementioned arc extinguishing system.

### BRIEF DESCRIPTION OF DRAWINGS

The advantages and objectives of the present disclosure can be better understood in the following detailed description of the preferred embodiment of the present disclosure with the accompanying drawings. The accompanying drawings are not drawn to scale in order to better show the relationship between the components in the drawings.

FIG. 1 shows a schematic diagram of an arc extinguishing system installed in a contactor according to the present application.

FIG. 2 shows a perspective view in which an arc striking piece of the arc extinguishing system according to the present application is connected to a stationary contact.

### DETAILED DESCRIPTION

In order to make the purpose, technical details and advantages of the technical solution of the present disclosure clearer, the technical solution of the embodiments of the present disclosure will be described clearly and completely with the accompanying drawings of specific embodiments of the present disclosure. Like reference numerals in the drawings represent like parts. It should be noted that the described embodiments are a part of the embodiments of the present disclosure, not all embodiments. Based on the described embodiments of the present disclosure, all other embodiments obtained by ordinary skilled in the art without creative labor belong to the scope of protection of the present disclosure.

Compared with the embodiments shown in the accompanying drawings, the feasible embodiments within the protection scope of the present disclosure may have fewer components, other components not shown in the accompanying drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by people with ordinary skills in the field to which the present disclosure belongs. The words “first”, “second” and similar words used in the specification and claims of the patent application of the present disclosure do not indicate any order, quantity or importance, but are only used to distinguish different components. When the number of parts is not specified, the number of parts can be one or more; Similarly, similar words such as “a”, “an”, “the” and “said” do not necessarily refer to quantity limitation. Similar words such as “including” or “containing” refer to that the elements or objects appearing before the word cover the elements or objects listed after the word and their equivalents, without excluding other elements or objects. Similar words such as “installation”, “setting”, “connection” or “connection” are not limited to physical or mechanical installation, setting and connection, but can include electrical installation, setting and connection, whether directly or indirectly. “Up”, “Down”, “Left” and “Right” are only used to indicate the relative orientation relationship when the equipment is used or the orientation relationship shown in the accompanying drawings. When the absolute position of the described object changes, the relative orientation relationship may also change accordingly.

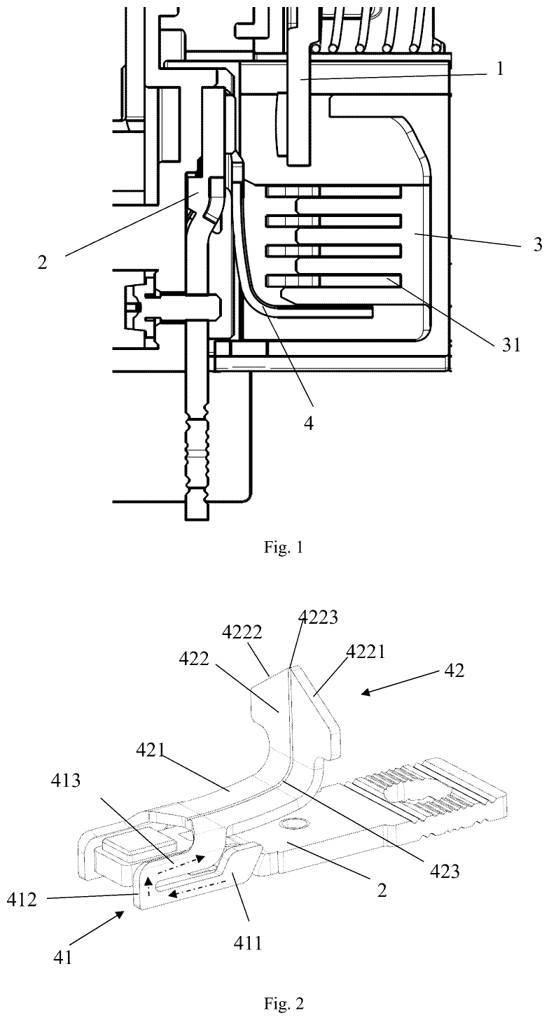

FIG. 1 shows a schematic diagram of an arc extinguishing system installed in a contactor according to the present application. The arc extinguishing system is installed in the contactor to extinguish the arc generated upon a movable contact 1 and a stationary contact 2 (straight stationary contact) of the contactor being separated. The arc extinguishing system includes an arc extinguishing chamber 3, which accommodates a plurality of arc extinguishing grids 31. Each of the plurality of arc extinguishing grids is used to divide a long arc introduced into the arc extinguishing chamber into a plurality of short arcs, so as to finally extinguish the arc. As illustrated by FIG. 1, an extension direction of each of the plurality of arc extinguishing grids is perpendicular to an extension direction of the movable contact, so that pollutants in the arc extinguishing grid are unlikely to fall on the movable contact and pollute the movable contact.

The arc extinguishing system further includes an arc striking piece 4 electrically connected to the stationary contact 2 and configured to extend toward the arc extinguishing chamber, so that the arc generated upon the movable contact 1 and the stationary contact 2 being separated moves along the arc striking piece toward the arc extinguishing chamber. The arc striking piece 4 includes a connection part 41 configured to be electrically connected to the stationary contact and a guide part 42 for guiding the arc, and the guide part 42 is not in contact with the stationary contact, that is, is spaced apart from the stationary contact.

As illustrated by FIG. 2, the connection part 41 includes a first part 411, a second part 413 and a bending part 412 connecting the first part and the second part. The first part, the second part and the bending part form a U-shape, in particular, at least a part of the first part, the bending part and the second part form a U-shape. The first part 411 is electrically connected to the stationary contact, and the second part 413 is connected to the guide part 42. In this way, a flow direction of the arc is opposite to the flow direction of the current from the movable contact to the stationary contact, and the arc moves outward towards the arc extinguishing chamber under the action of the magnetic field. The arc striking piece 4 is made of magnetic conductive material. Once an arc is formed, it will shield the negative influence of the current generated between the movable contact and the stationary contact on the magnetic field, so that the arc can enter the arc extinguishing grid more easily.

The guide part 42 includes a tail part 422 extending substantially perpendicular to the stationary contact and a transition part 421 connecting the second portion 413 and the tail part, that is, the shape of the guide part is designed to be gradually changed to be substantially perpendicular to the stationary contact.

The tail part 422 is shaped like an arrow, that is, the tail part 422 includes a first inclined lateral edge 4221 and a second inclined lateral edge 4222, so that the first inclined lateral edge and the second inclined lateral edge converge towards the middle of the tail part to form a tip 4223.

The guide part 42 also includes a groove 423 centrally arranged in the guide part 42, which helps the arc to move centrally along the arc striking piece upon the arc not forming a path on the guide part 42.

As illustrated by FIG. 1, the guide part 42 extends past the plurality of arc extinguishing grids, so that the guide part partially surrounds the plurality of arc extinguishing grids, that is, upon the arc moving along the guide part, the arc can move toward all the arc extinguishing grids, thereby extinguishing the arc more quickly.

The application also provides a contactor, which comprises the arc extinguishing system.

Through the arc extinguishing system, pollutants on the arc extinguishing grid can be prevented from falling on the movable contact, and the pollution to the movable contact is reduced; by the special shape of J-shaped arc striking piece, the arc can be better guided to the arc extinguishing chamber, the arc extinguishing effect is optimized and the electrical life of the product is increased. The contactor provided by the present disclosure includes a straight stationary contact, so that the used copper bar material is reduced, the product cost is reduced, the process is simple, the size control precision is high, and the overall size of the product is more compact.

It is obvious to those skilled in the art that the present disclosure is not limited to the details of the above-mentioned exemplary embodiments, and can be realized in other specific forms without departing from the spirit or basic characteristics of the present disclosure. Therefore, no matter from which point of view, the embodiments should be regarded as exemplary and non-limiting. The scope of the present disclosure is defined by the appended claims rather than the above description, so it is intended to include all changes that fall within the meaning and scope of the equivalent elements of the claims. Any reference signs in the claims shall not be construed as limiting the claims concerned.

In addition, it should be understood that although this specification is described in terms of embodiments, not every embodiment only contains an independent technical solution, and this description of the specification is only for the sake of clarity. Those skilled in the art should take the specification as a whole, and the technical solutions in various embodiments can also be combined appropriately to form other embodiments that can be understood by those skilled in the art.

1. An arc extinguishing system for a contactor, used for extinguishing an arc generated upon a movable contact and a stationary contact of the contactor being separated, wherein the arc extinguishing system comprises:
an arc extinguishing chamber, accommodating a plurality of arc extinguishing grids, and an extension direction of each of the plurality of arc extinguishing grids being perpendicular to an extension direction of the movable contact;
an arc striking piece, electrically connected to the stationary contact and configured to extend toward the arc extinguishing chamber, so that the arc generated upon the movable contact and the stationary contact being separated moves along the arc striking piece toward the arc extinguishing chamber.

2. The arc extinguishing system according to claim 1, wherein the arc striking piece comprises a connection part configured to be electrically connected to the stationary contact and a guide part spaced apart from the stationary contact and guiding the arc.

3. The arc extinguishing system according to claim 2, wherein the connection part comprises a first part, a second part and a bending part connecting the first part and the second part, the first part, the bending part and the second part form a substantially U-shape, the first part is electrically connected to the stationary contact, and the second part is connected to the guide part, and the arc flows from the first part to the second part through the bending part.

4. The arc extinguishing system according to claim 3, wherein the guide part comprises a tail part extending perpendicular to the stationary contact and a transition part connecting the second part and the tail part.

5. The arc extinguishing system according to claim 4, wherein the guide part comprises a groove centrally arranged in the guide part.

6. The arc extinguishing system according to claim 4, wherein the tail part comprises a first inclined lateral edge and a second inclined lateral edge, so that the first inclined lateral edge and the second inclined lateral edge converge towards a middle of the tail part to form a tip.

7. The arc extinguishing system as claimed in claim 4, wherein the guide part extends past the plurality of arc extinguishing grids so that the guide part partially surrounds the plurality of arc extinguishing grids.

8. A contactor, comprising the arc extinguishing system according to claim 1.
